(19) United States
(12) Patent Application Publication
(10) Pub. No.: US 2018/0251210 A1
(43) Pub. Date: Sep. 6, 2018

(54) VEHICLE CONTROL SYSTEMS

(71) Applicant: Sikorsky Aircraft Corporation, a Lockheed Martin Company, Stratford, CT (US)

(72) Inventors: David Adams, Wallingford, CT (US); William Fell, Stuart, FL (US)

(21) Appl. No.: 15/910,910

(22) Filed: Mar. 2, 2018

Related U.S. Application Data
(60) Provisional application No. 62/466,919, filed on Mar. 3, 2017.

(51) Int. Cl. B64C 13/04; G05D 1/10; B64C 27/56; G05G 9/047; B64C 13/18; B64C 13/50; B64C 13/12

(52) U.S. Cl. CPC B64C 13/0421; G05D 1/102; B64C 27/56; B64C 13/12; B64C 13/18; B64C 13/503; G05G 9/04788

(57) ABSTRACT

A vehicular control system can include a control device including one or more control inputs, and a control switch operatively connected to the control device for receiving control input signals from the control device, the control switch configured to switch between a vehicle control mode such that the control input signals control one or more vehicle motion control components and at least one mission mode such that the control input signals control one or more other devices.

### CROSS-REFERENCE TO RELATED APPLICATIONS

This application claims the benefit of U.S. Provisional Patent Application No. 62/466,919 filed on Mar. 3, 2017, the entire contents of which is incorporated herein by reference.

### BACKGROUND

### 1. Field

The present disclosure relates to vehicle control systems, e.g., aircraft control systems.

### 2. Description of Related Art

Certain helicopter cockpits optimize the pilot vehicle interface to the aircraft to ensure ease of operations for its various missions and enhance product safety. Modern civil, EMS, and military helicopter require higher levels of pilot interaction with increasing numbers of sensors and systems, to safely accomplish these missions. Instrument panel size is minimized in favor of field of view out of the windscreen. Therefore, cockpit space is at a premium and is focused on basic air vehicle control and display capabilities.

Current systems typically add controllers, dedicated to a function or group of functions, e.g., a FLIR/EO/IR sensor. In space constrained aircraft cockpits, these controllers cannot be optimally located for operator control and sometimes do not fit at all.

Such conventional methods and systems have generally been considered satisfactory for their intended purpose. However, there is still a need in the art for improved vehicular control systems. The present disclosure provides a solution for this need.

### SUMMARY

A vehicular control system can include a control device including one or more control inputs, and a control switch operatively connected to the control device for receiving control input signals from the control device, the control switch configured to switch between a vehicle control mode such that the control input signals control one or more vehicle motion control components and at least one mission mode such that the control input signals control one or more other devices.

The control device can be a joystick for example. The control inputs can include at least two axis control motion.

The control device can include one or more control actuators mounted thereon configured to perform a first function in the control mode and a second function in each mission mode. The control actuators can include one or more switches, buttons, dials, or joysticks. The one or more control actuators can include at least one mode switch actuator for switching between the control mode and the at least one mission mode.

In certain embodiments, the vehicle can be an aircraft. The one or more vehicle control components can therefore include at least one control surface.

The system can include at least one flight computer. The control switch can be included in the at least one flight computer, for example, or can be a separate module.

The flight computer can be operatively connected to the at least one control surface in the control mode to control motion of the aircraft. The system can include a mission module operatively connected to the flight computer, and the flight computer can be configured to provide the mission module with control input signals when in the at least one mission mode to control the one or more other devices.

The one or more other devices can include at least one of steerable sensor, a steerable weapon system, an unmanned aerial system control, or an unmanned aerial system sensor, for example. Any other suitable devices are contemplated herein.

In accordance with at least one aspect of this disclosure, a non-transitory computer readable medium can include computer executable instructions for executing a method. The method can include receiving a mode switching command from a control device, and switching between a control mode and a mission mode such that control input signals from the control device control one or more vehicle motion control components in the control mode and the control input signals control one or more other devices in the mission mode.

The method can include receiving control input signals from the control device. Switching between the control mode and the mission mode includes switching a flight control computer between one or more control surface actuators and a mission module such that the flight control computer controls the control surface actuators as a function of the control input signals in the control mode, and such that the mission module controls the one or more other devices in the mission mode.

The method can include preventing switching from the control mode to the mission mode when the control device not in a predetermined position or predetermined range of positions. For example, the predetermined position can be detent such that when the control device is out of detent, mission mode cannot be switched to from control mode.

These and other features of the systems and methods of the subject disclosure will become more readily apparent to those skilled in the art from the following detailed description taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, embodiments thereof will be described in detail herein below with reference to certain figures, wherein:

FIG. 1 is a schematic view of an embodiment of a system in accordance with this disclosure, shown switched to mission mode; and

FIG. 2 is a schematic view of an embodiment of a control device in accordance with this disclosure.

### DETAILED DESCRIPTION

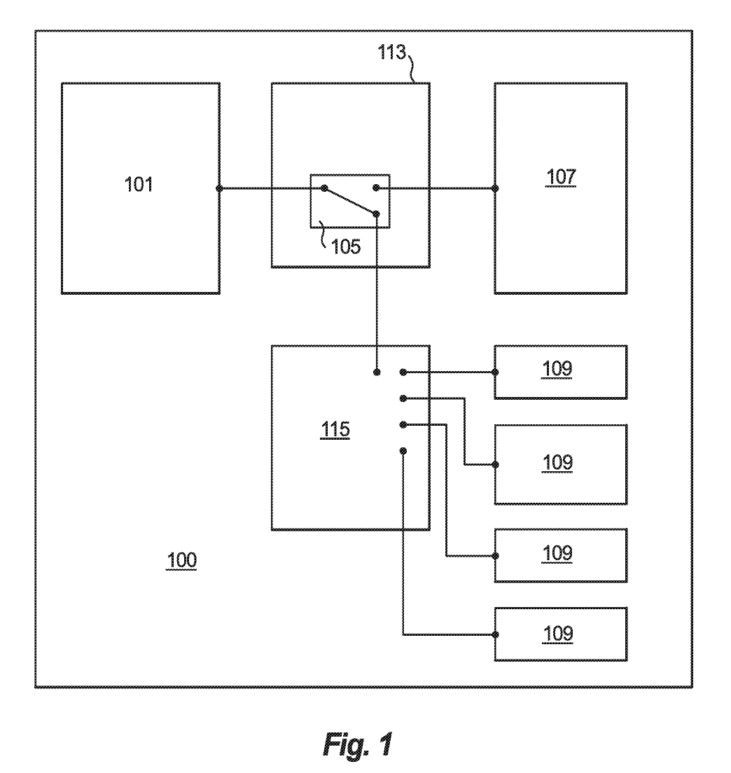

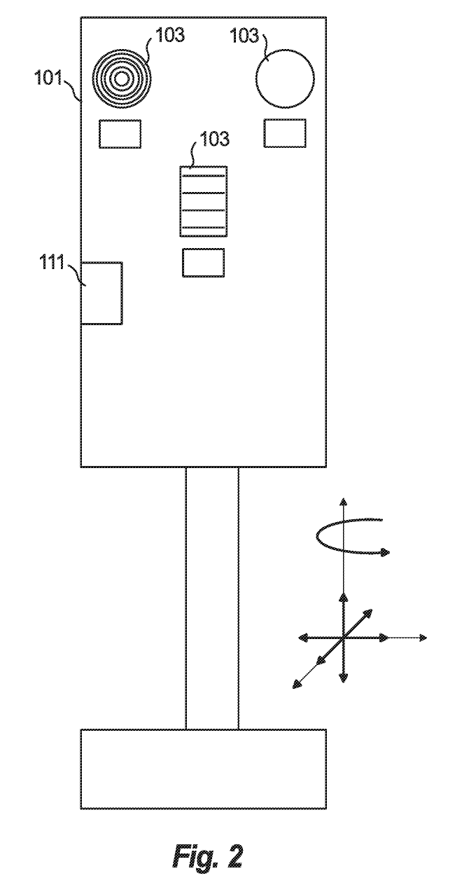

Reference will now be made to the drawings wherein like reference numerals identify similar structural features or aspects of the subject disclosure. For purposes of explanation and illustration, and not limitation, an illustrative view of an embodiment of a system in accordance with the disclosure is shown in FIG. 1 and is designated generally by reference character 100. Other embodiments and/or aspects of this disclosure are shown in FIG. 2. The systems and methods described herein can be used to improve efficiency of space and control within a cockpit, for example.

Referring to FIG. 1, a vehicular control system 100 can include a control device 101. Referring additionally to FIG. 2, the control device 101 can include one or more control inputs. The system 100 includes a control switch 105 operatively connected to the control device 101 for receiving control input signals from the control device 101. The control switch 105 is configured to switch between a vehicle control mode such that the control input signals control one or more vehicle motion control components 107 and at least one mission mode (e.g., as shown in FIG. 1) such that the control input signals control one or more other devices 109.

As shown in FIG. 2, the control device 101 can be a joystick for example. For example, in certain embodiments, the control inputs can include at least two axis control motion (e.g., pitch and roll) from the joystick. Any suitable control device 101 is contemplated herein.

The control device 101 can include one or more control actuators 103 mounted thereon configured to perform a first function in the control mode (e.g., one or more aircraft control functions) and a second function in each mission mode (e.g., non-aircraft control related functions). The control actuators 103 can include one or more switches, buttons, dials, or joysticks. Any suitable control actuator 103 is contemplated herein for any suitable function (e.g., aircraft trim in the control mode).

The one or more control actuators 103 can include at least one mode switch actuator 111 for switching between the control mode and the at least one mission mode. The mode switch actuator 111 can be a button, switch, or any other suitable actuator.

In certain embodiments, the vehicle can be an aircraft, however, embodiments of a system 100 can be applied in any suitable vehicle (e.g., a submarine). The one or more vehicle control components 107 can therefore include at least one control surface actuator (e.g., for a fly-by-wire aileron, rudder, elevator, propeller/blade control, etc.).

In certain embodiments, as shown in FIG. 1, the system 100 can include at least one flight computer 113. The control switch 105 can be included in the at least one flight computer 113, for example, or can be a separate module. For example, the control switch 105 can be a module (e.g., including any suitable software and/or hardware) of the flight computer 113 such that the flight computer can control the one or more motion control devices 107 in the control mode. Accordingly, the flight computer 113 can be operatively connected to at least one control surface in the control mode to control motion of the aircraft.

As shown in FIG. 1, the system can include a mission module 115 operatively connected to the flight computer 113, and the flight computer 113 can be configured to provide the mission module 115 with control input signals when in the at least one mission mode to control the one or more other devices 109. While the mission module 115 is shown as a separate component, it is contemplated that the mission module can be part of the flight computer 113.

The mission module 115 can include any suitable hardware (e.g., one or more processors and a memory) and/or software (e.g., suitable computer code). The mission module 115 can be configured to process the control input signals from the control device 101 and control the other devices 109 as a function of the control input signals. In certain embodiments, the flight control computer 113 can communicate directly with the other devices 109 to control the other devices 109. The flight control computer 113 can be used for remote control of the vehicle and/or for autopilot of the vehicle as appreciated by those having ordinary skill in the art.

The one or more other devices 109 can include at least one of steerable sensor, a steerable weapon system, an unmanned aerial system control, or an unmanned aerial system sensor, for example. Any other suitable devices are contemplated herein.

In accordance with at least one aspect of this disclosure, a non-transitory computer readable medium can include computer executable instructions for executing a method. The method can include receiving a mode switching command from a control device 101 and switching between a control mode and a mission mode such that control input signals from the control device 101 control one or more vehicle motion control components 107 in the control mode and the control input signals control one or more other devices 109 in the mission mode.

The method can include receiving control input signals from the control device 101. Switching between the control mode and the mission mode can include switching a flight control computer 113 between one or more control surface actuators and a mission module 115 such that the flight control computer 113 controls the control surface actuators as a function of the control input signals in the control mode, and such that the mission module 115 controls the one or more other devices 109 in the mission mode.

The method can include preventing switching from the control mode to the mission mode when the control device 101 not in a predetermined position or predetermined range of positions. This can be done using any suitable hardware and/or software, e.g., in the flight control computer and/or control switch 105. For example, the predetermined position can be detent (e.g., neutral input) such that when the control device is out of detent, mission mode cannot be switched to from control mode (e.g., to prevent loss of control of the aircraft). The converse can also be true such that switching back from mission mode can be prevented when the control device 101 is outside of a predetermined position or range thereof.

As described above, a control device that can be switched to provide control of a vehicle (e.g., an aircraft such as a helicopter) or other suitable mission functions can greatly enhanced the mission effectiveness and reduce or eliminate dedicated controllers for each mission function. This can enhance the efficiency and ergonomics of the cockpit.

Referring to aircraft applications, fly-by-wire technology can be an avenue to allow above embodiments to be used since such existing systems are all digital anyway. As appreciated by those having ordinary skill in the art, modern aircraft design frequently implement Full Authority Flight Control Systems (utilizing fly-by-wire technology). This enabling technology replaces the mechanical linkages between the control sticks/devices and the control surfaces, with electrical connections and software managed control. The ability to decouple the control input devices from the air vehicle control opens up a new and novel control strategy to repurpose the existing aircraft control device for other functions, such as controlling onboard or off board sensors, weapons, or unmanned airborne platforms.

The existing control devices for aircraft control typically provide multi-axis input to the Flight Control Computers (i.e. pitch, roll, azimuth, and up/down), as well as dedicated switches to manage air vehicle and mission control functions. In this new control scheme, the control device multi-axis inputs and switches can be switched from air vehicle control to support any one of numerous other mission functions. In order to maintain compliance with Human Factors design guidelines, each switch can be clearly labeled as to its allocated function. Embodiments to achieve this can include physical marking on the grip for up to a dual use function (e.g., of the mode switching actuator 111). For multi-purpose functions, an embedded, conformal, programmable, miniature display can be collocated with each applicable grip switch. As described above, embodiments of the flight control computer 113 can provide arbitration of all the controller axis and switches to the system requiring its usage.

In certain embodiments, there must be clear delineation of who is flying the aircraft before the mode of a control device 101 can be switched. For aircraft with redundant control systems, it is contemplated that embodiments can allow only one control device 101 to be in mission mode while the other has to be in flight mode and controlled by other pilot. In this regard, any suitable authentication is contemplated herein.

For example, the pilot that wants to use mission mode can be required to have other pilot press (e.g., simultaneously or within some predefined period of time) the mode switching actuator 111 on their control device 101 to ensure safe transfer. In certain embodiments, both could be in control devices in a dual redundant system can be in control mode, or one could always be in mission mode. There may be a control mode release actuator (e.g., on the instrument panel) for resetting one or more control devices to control mode.

The ability to utilize a multi-purpose controller to manage aircraft control function or onboard, off-board, or unmanned air vehicle control, reduces the complexity of the cockpit, places control in optimal location (ergonomically), and removes separate/dedicated controllers. This can greatly enhance the ability for crew members to manage complex missions, without complex cockpit interfaces.

By way of example, aspects of the invention can be used in coaxial helicopters, on tail rotors, or wings or propeller blades on fixed or tilt wing aircraft. Any other suitable use for any other suitable application and/or any other suitable vehicle (e.g., watercraft, landcraft) is contemplated herein.

As will be appreciated by those skilled in the art, aspects of the present disclosure may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified herein.

The methods and systems of the present disclosure, as described above and shown in the drawings, provide for control systems with superior properties. While the apparatus and methods of the subject disclosure have been shown and described with reference to embodiments, those skilled in the art will readily appreciate that changes and/or modifications may be made thereto without departing from the spirit and scope of the subject disclosure.

What is claimed is:

1. A vehicular control system, comprising:
a control device including one or more control inputs;
a control switch operatively connected to the control device for receiving control input signals from the control device, the control switch configured to switch between a vehicle control mode such that the control input signals control one or more vehicle motion control components and at least one mission mode such that the control input signals control one or more other devices.

2. The system of claim 1, wherein the control device is a joystick, wherein the control inputs include at least two axis control motion.

3. The system of claim 1, wherein the control device includes one or more control actuators mounted thereon configured to perform a first function in the control mode and a second function in each mission mode.

4. The system of claim 3, wherein the control actuators include one or more switches, buttons, dials, or joysticks.

5. The system of claim 3, wherein the one or more control actuators include at least one mode switch actuator for switching between the control mode and the at least one mission mode.

6. The system of claim 1, wherein the vehicle is an aircraft, wherein the one or more vehicle control components include at least one control surface.

7. The system of claim 6, further comprising at least one flight computer, wherein the control switch is included in the at least one flight computer.

8. The system of claim 7, wherein the flight computer is operatively connected to the at least one control surface in the control mode to control motion of the aircraft.

9. The system of claim 8, further comprising a mission module operatively connected to the flight computer, wherein the flight computer is configured to provide the mission module with control input signals when in the at least one mission mode to control the one or more other devices.

10. The system of claim 1, wherein the one or more other devices include at least one of steerable sensor, a steerable weapon system, an unmanned aerial system control, or an unmanned aerial system sensor.

11. A non-transitory computer readable medium comprising computer executable instructions for executing a method, the method including:
receiving a mode switching command from a control device;
switching between a control mode and a mission mode such that control input signals from the control device control one or more vehicle motion control components in the control mode and the control input signals control one or more other devices in the mission mode.

12. The non-transitory computer readable medium of claim 11, wherein the method further includes receiving control input signals from the control device.

13. The non-transitory computer readable medium of claim 11, wherein switching between the control mode and the mission mode includes switching a flight control computer between one or more control surface actuators and a mission module such that the flight control computer controls the control surface actuators as a function of the control input signals in the control mode, and such that the mission module controls the one or more other devices in the mission mode.

14. The non-transitory computer readable medium of claim 11, wherein the method further includes preventing switching from the control mode to the mission mode when the control device not in a predetermined position or predetermined range of positions.

15. The non-transitory computer readable medium of claim 14, wherein the predetermined position is detent such that when the control device is out of detent, mission mode cannot be switched to from control mode.
